(19) United States
(12) Patent Application Publication
(10) Pub. No.: US 2026/0289850 A1
(43) Pub. Date: Sep. 24, 2026

(54) MODEL TRAINING METHOD, PICTURE GENERATION METHOD AND APPARATUS, MEDIUM, AND ELECTRONIC DEVICE

(71) Applicant: Beijing Zitiao Network Technology Co., Ltd., Beijing (CN)

(72) Inventors: Fei LIU, Beijing (CN); Wei LIU, Beijing (CN)

(21) Appl. No.: 19/469,951

(22) PCT Filed: Mar. 29, 2024
(86) PCT No.: PCT/CN2024/084744

§ 371 Date: Sep. 26, 2025

(30) Foreign Application Priority Data
Mar. 30, 2023 (CN) 202310333549.1

(51) Int. Cl. G06T 11/60; G06N 20/00

(52) U.S. Cl. CPC G06T 11/60; G06N 20/00

(57) ABSTRACT

The present disclosure relates to a method. The method includes: acquiring a stylized picture to be trained and a generic picture to be trained, where the generic picture to be trained is a picture which is similar in content to the stylized picture to be trained but does not possess style; constructing training data based on the stylized picture to be trained and the generic picture to be trained, where the training data includes the stylized picture to be trained and a first text description paired with the stylized picture to be trained, and the generic picture to be trained and a second text description paired with the generic picture to be trained, and the first text description includes a style feature vector to be trained; and training the stylized picture generation model based on the training data.

The present application claims the priority to Chinese Patent Application No. 202310333549.1, filed on Mar. 30, 2023, the entire disclosure of which is incorporated herein by reference as portion of the present application.

### TECHNICAL FIELD

Embodiments of the present disclosure relate to a method for training a model, a method and an apparatus for generating a picture, a medium, and an electronic device.

### BACKGROUND

In the related art, to generate a stylized picture, a common approach is to train a model using a large number of stylized pictures along with paired text descriptions, and words with style (e.g., oil painting style) may be added to the paired text descriptions to guide model training. However, in many scenarios, on the one hand, it is often unable to collect a sufficient number of stylized pictures as training samples; and on the other hand, it is difficult to describe the style features of some stylized pictures in text, making it impossible to use explicit style words or labels to guide model training.

### SUMMARY

The summary is provided to introduce concepts briefly, and these concepts will be described in detail in the following detailed description. The summary is neither intended to indicate the key features or essential features of the claimed technical solutions nor intended to limit the scope of the claimed technical solutions.

In a first aspect, the present disclosure provides a method for training a stylized picture generation model, which includes: acquiring a stylized picture to be trained and a generic picture to be trained, where the generic picture to be trained is a picture which is similar in content to the stylized picture to be trained but does not possess style; constructing training data based on the stylized picture to be trained and the generic picture to be trained, where the training data includes the stylized picture to be trained and a first text description paired with the stylized picture to be trained, and the generic picture to be trained and a second text description paired with the generic picture to be trained, and the first text description includes a style feature vector to be trained; and training the stylized picture generation model based on the training data.

In a second aspect, the present disclosure further provides a method for generating a stylized picture, which includes: receiving a picture to be stylized input by a user; and processing the picture to be stylized using a stylized picture generation model to generate the stylized picture, where the stylized picture generation model is a model trained based on the method for training a stylized picture generation model according to the first aspect.

In a third aspect, the present disclosure further provides an apparatus for training a stylized picture generation model, which includes: an acquisition module, configured to acquire a stylized picture to be trained and a generic picture to be trained, where the generic picture to be trained is a picture which is similar in content to the stylized picture to be trained but does not possess style; a construction module, configured to construct training data based on the stylized picture to be trained and the generic picture to be trained, where the training data includes the stylized picture to be trained and a first text description paired with the stylized picture to be trained, and the generic picture to be trained and a second text description paired with the generic picture to be trained, where the first text description includes a style feature vector to be trained; and a training module, configured to train the stylized picture generation model based on the training data.

In a fourth aspect, the present disclosure further provides an apparatus for generating a stylized picture, which includes: a receiving module, configured to receive a picture to be stylized input by a user; and a generation module, configured to process the picture to be stylized using a stylized picture generation model to generate the stylized picture, where the stylized picture generation model is a model trained based on the method for training a stylized picture generation model according to the first aspect.

In a fifth aspect, the present disclosure further provides a computer-readable medium storing a computer program, and the computer program, when executed by a processing apparatus, implements steps of the method according to the first aspect.

In a sixth aspect, the present disclosure further provides an electronic device, which includes a storage apparatus storing a computer program, and a processing apparatus configured to execute the computer program in the storage apparatus to implement steps of the method according to the first aspect.

Other features and advantages of the present disclosure will be described in detail in the following detailed description.

### BRIEF DESCRIPTION OF DRAWINGS

In conjunction with the drawings and with reference to the following detailed description, the above-mentioned and other features, advantages, and aspects of the various embodiments of the present disclosure will become more apparent. Throughout the drawings, the same or similar reference numerals denote the same or similar elements. It should be understood that the drawings are illustrative and the components and elements are not necessarily drawn to scale.

FIG. 1 is a flowchart of a method for training a stylized picture generation model according to an embodiment of the present disclosure;

FIG. 2 is a schematic block diagram of training a stylized picture generation model according to an embodiment of the present disclosure;

FIG. 3 is a flowchart of a method for generating a stylized picture according to an embodiment of the present disclosure;

FIG. 4 is an effect diagram of a stylized picture generated by a method for generating a stylized picture according to the present disclosure;

FIG. 5 is a schematic block diagram of an apparatus for training a stylized picture generation model according to an embodiment of the present disclosure;

FIG. 6 is a schematic block diagram of an apparatus for generating a stylized picture according to an embodiment of the present disclosure; and FIG. 7 is a schematic structural diagram of an electronic device adapted to implement the embodiments of the present disclosure.

### DETAILED DESCRIPTION

Embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

It should be understood that the various steps described in the method embodiments of the present disclosure may be performed in different orders and/or in parallel. Furthermore, the method embodiments may include additional steps and/or omit performing the illustrated steps. The protection scope of the present disclosure is not limited in this aspect.

As used herein, the term “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different devices, modules or units, and are not used to limit the interdependence relationship or the order of functions performed by these devices, modules or units.

It should be noted that the modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

The names of the messages or information exchanged between a plurality of apparatuses in the embodiments of the present disclosure are for illustrative purposes only and are not intended to limit the scope of these messages or information.

It may be understood that before using the technical solutions disclosed in the embodiments of the present disclosure, it is necessary to inform user(s) the types, using scope, and using scenarios of personal information involved in the present disclosure according to relevant laws and regulations in an appropriate manner and obtain the authorization of the user(s).

For example, in response to receiving a user's active request, a prompt message is sent to the user to clearly remind the user that the requested operation will require acquiring and using the user's personal information. Thus, users can selectively choose whether to provide personal information to the software or hardware such as an electronic device, an application, a server, or a storage medium that perform the operations of the technical solutions of the present disclosure according to the prompt message.

As an optional but non-restrictive implementation, in response to receiving the user's active request, sending the prompt message to the user may be done in the form of a pop-up window, where the prompt message may be presented in text. In addition, the pop-up window may further carry a selection control for users to choose between “agree” or “disagree” to provide the personal information to an electronic device.

It may be understood that the above-mentioned processes of informing and acquiring user authorization are only illustrative and do not limit the embodiments of the present disclosure. Other methods that comply with relevant laws and regulations may also be applied to the embodiments of the present disclosure.

Furthermore, it may be understood that the data involved in the technical solutions (including but not limited to the data itself, data acquisition or use) should comply with the requirements of corresponding laws, regulations and relevant provisions.

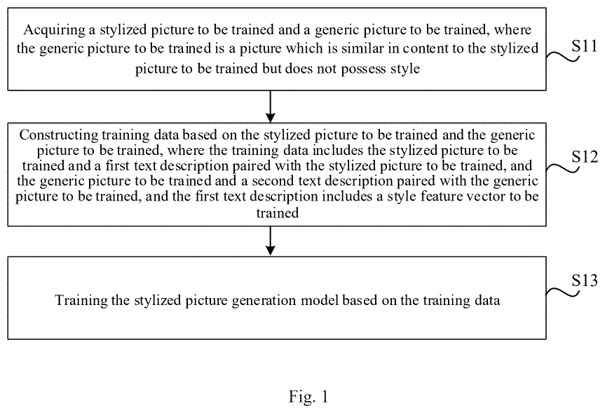

FIG. 1 is a flowchart of a method for training a stylized picture generation model according to an embodiment of the present disclosure. As shown in FIG. 1, the method includes the following steps S11 to S13.

Step S11, acquiring a stylized picture to be trained and a generic picture to be trained, where the generic picture to be trained is a picture which is similar in content to the stylized picture to be trained but does not possess style.

The stylized picture refers to a picture possessing a certain style type (e.g., oil painting style, some styles that cannot be described with explicit style words, etc.). The stylized picture to be trained may be acquired from a user. Moreover, the number of stylized pictures to be trained of the same style does not need to be large, and the training of a style can also be achieved with very few stylized pictures to be trained of the same style (e.g., 3 to 5 pictures, or even just 1 picture).

The generic picture may be, for example, a real picture which is similar in content to the stylized picture to be trained and embodies a real scene.

The following provides examples to illustrate how the generic picture to be trained is similar in content to the stylized picture to be trained. For example, if the stylized picture to be trained includes a girl with a helmet and the part of the girl possesses a certain style, the generic picture to be trained also includes a girl with a helmet, but the girl does not possess any style. That is, the stylized picture to be trained and the generic picture to be trained are similar in content, namely the girl with the helmet, except that the part of the girl in the stylized picture to be trained possesses a certain style.

In some embodiments, acquiring the generic picture to be trained may be implemented in the following method. Firstly, a corresponding textual description is generated for the stylized picture to be trained. For example, a text generation model may be adopted to generate a corresponding textual description for each stylized picture to be trained. Then, the generic picture to be trained is generated based on the generated textual description. For example, a pre-trained diffusion model may be used to generate a batch of generic pictures to be trained based on the generated textual descriptions. This batch of generic pictures to be trained possess content similar to the stylized pictures to be trained.

In addition, after the generic picture to be trained is generated based on the generated textual description, the generated generic picture to be trained may also be augmented at different scales. Thus, more training samples can be acquired, thereby addressing the issue of limited training data.

In some embodiments, acquiring the stylized picture to be trained may be implemented in the following method. Firstly, a stylized picture input by the user is received. The stylized picture input by the user is then augmented at different scales to obtain the stylized picture to be trained. Thus, more training samples can be acquired, thereby addressing the issue of limited training data.

Step S12, constructing training data based on the stylized picture to be trained and the generic picture to be trained, where the training data includes the stylized picture to be trained and a first text description paired with the stylized picture to be trained, and the generic picture to be trained and a second text description paired with the generic picture to be trained, and the first text description includes a style feature vector to be trained. The style feature vector is used for representing a style type of the stylized picture to be trained.

The second text description does not include any style feature vector to be trained.

In some embodiments, the first text description is constructed in the following method. Firstly, the corresponding textual description is generated for the stylized picture to be trained. For example, the text generation model may be adopted to generate the corresponding textual description for each stylized picture to be trained. The style feature vector to be trained is then added to the generated textual description to obtain the first text description.

In some embodiments, the first text description may also be constructed in the following method. Firstly, a textual description input by a user and corresponding to the stylized picture to be trained is received. The style feature vector to be trained is then added to the textual description to obtain the first text description.

In some embodiments, for the above-mentioned stylized picture to be trained and the generic picture to be trained obtained by augmenting, corresponding prefixes may be added to the corresponding text descriptions. For example, when zooming in, the description “zoom in” may be attached to the corresponding text description. In this way, the first text description corresponding to the stylized picture to be trained obtained by augmenting and the second text description corresponding to the generic picture to be trained obtained by augmenting are obtained.

In some embodiments, the constructed training data may take the following form:
(stylized picture to be trained, paired first text description)
(generic picture to be trained, paired second text description)

Step S13, training the stylized picture generation model based on the training data.

The stylized picture generation model may be a diffusion model or other models capable of generating pictures from pictures.

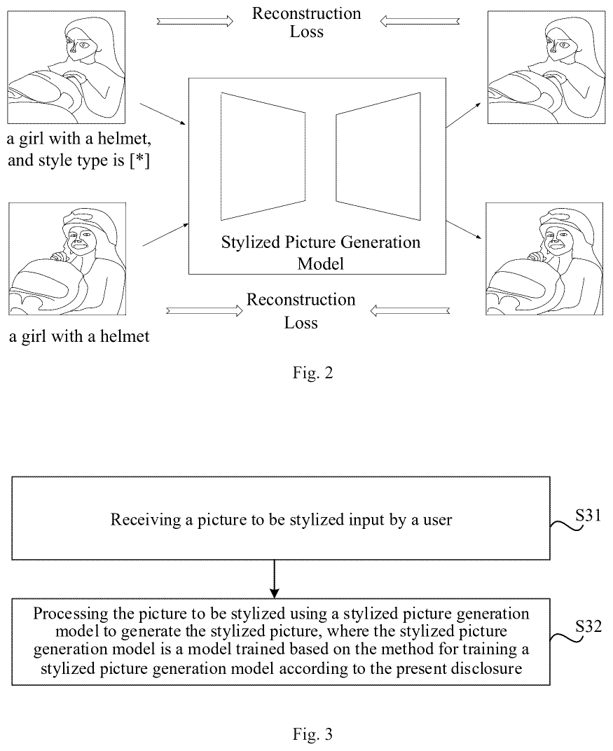

In some embodiments, in the process of training, the training data may be input into the stylized picture generation model to obtain a stylized picture and a generic picture output by the stylized picture generation model. A reconstruction loss between the stylized picture to be trained and the stylized picture output by the stylized picture generation model, and a reconstruction loss between the generic picture to be trained and the generic picture output by the stylized picture generation model are then calculated. Then, the stylized picture generation model is corrected based on the reconstruction losses, and in response to the calculated reconstruction losses meeting a preset condition, a trained stylized picture generation model is obtained. Taking what is shown in FIG. 2 as an example, the stylized picture to be trained is shown at the top left corner, where “[*]” represents the style feature vector to be trained. The generic picture to be trained is shown at the bottom left corner; the stylized picture output by the trained stylized picture generation model is shown at the top right corner; and the generic picture output by the trained stylized picture generation model is shown at the bottom right corner. The trained stylized picture generation model can calculate a reconstruction loss between the picture at the top left corner and the picture at the top right corner, and a reconstruction loss between the picture at the bottom left corner and the picture at the bottom right corner; and in response to the reconstruction losses meeting the preset condition, the trained stylized picture generation model can be obtained. After the completion of training, the user can use the trained stylized picture generation model to stylize any picture to output the picture in the style shown at the top left corner in FIG. 2. By using the stylized picture to be trained and the generic picture to be trained for training, the content in the stylized picture to be trained can be counterbalanced using the generic picture to be trained. This ensures that the content in the stylized picture to be trained may not be learned as a style, thus ensuring the accuracy of the style learning result.

With the above-mentioned technical solution, the stylized picture to be trained and the generic picture to be trained possessing the similar content and their respective corresponding text descriptions are utilized to train the pictures of a certain style, and the text description of the stylized picture to be trained includes the style feature vector to be trained. That is, in the training process of the present disclosure, the stylized picture to be trained and the generic picture to be trained are combined for training, and the style feature vector to be trained is combined with the stylized picture generation model for training. Therefore, even though there are no sufficient stylized pictures of the same style, the stylized picture generation model can be trained with respect to the stylized pictures of the style type. Even though the style characteristics of the stylized pictures of a certain type cannot be described and tagged with explicit style words, the stylized picture generation model can be trained with respect to the stylized pictures of the style type. As a result, the method for training a stylized picture generation model according to the present disclosure can be enabled to train the stylized pictures of any style type defined by the user. Moreover, the method for training a stylized picture generation model according to the present disclosure further has the advantages of low training overhead, small training data requirement, low cost, simplicity and convenience, etc., and can achieve the training effect rapidly and facilitate personal training by the user.

FIG. 3 is a flowchart of a method for generating a stylized picture according to an embodiment of the present disclosure. As shown in FIG. 3, the method for generating a stylized picture may include the following steps S31 and S32.

Step S31, receiving a picture to be stylized input by a user.

Step S32, processing the picture to be stylized using a stylized picture generation model to generate the stylized picture, where the stylized picture generation model is a model trained based on the method for training a stylized picture generation model according to the present disclosure.

In the process of generating the stylized picture, the stylized picture generation model is capable of automatically generating a textual description corresponding to the picture to be stylized input by the user and automatically adding a style feature vector learned when training to the textual description such that the picture to be stylized input by the user is changed to a picture of a style desired by the user.

Similarly, if the user input the textual description of the picture in step S31, then in step S32, the stylized picture generation model can also automatically add the style feature vector learned when training to the textual description input by the user, to output the picture of the style desired by the user according to the textual description input by the user.

With the above-mentioned technical solution, because the stylized picture generation model is the model trained based on the method for training a stylized picture generation model of the present disclosure, the stylized picture of the style desired by the user can be rapidly output for the user.

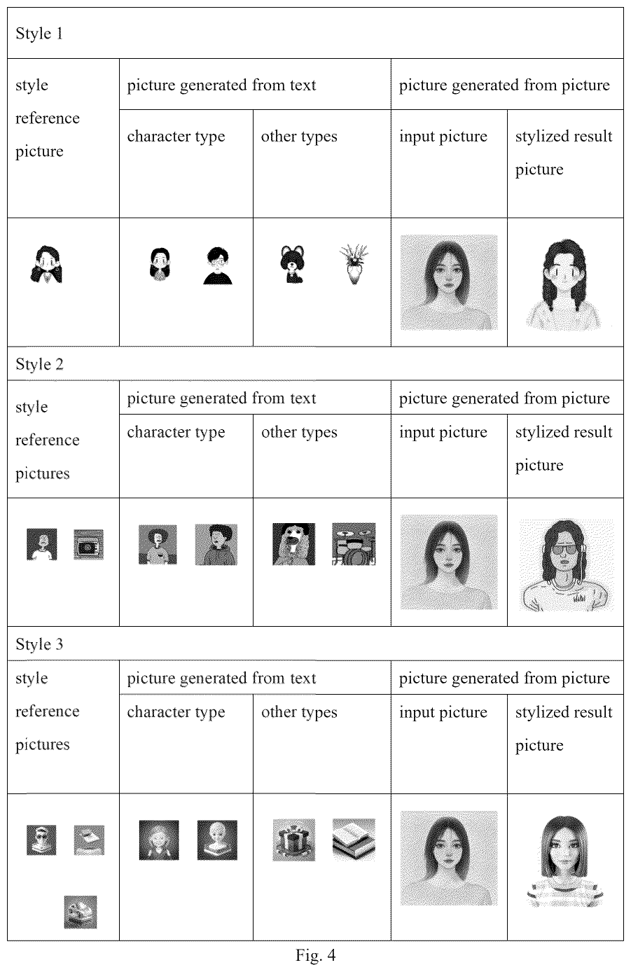

FIG. 4 is an effect diagram of a stylized picture generated by a method for generating a stylized picture according to the present disclosure. The style reference pictures in FIG. 4 are pictures of styles defined by a user, and the stylized picture generation model can be trained by the training method of the present disclosure and using these few style reference pictures. For example, for Style 1, the stylized picture generation model is trained using one style reference picture provided by the user so that the trained stylized picture generation model can output a stylized picture of Style 1. For Style 2, the stylized picture generation model is trained using two style reference pictures provided by the user so that the trained stylized picture generation model can output a stylized picture of Style 2. For Style 3, the stylized picture generation model is trained using three style reference pictures provided by the user so that the trained stylized picture generation model can output a stylized picture of Style 3. After the completion of training, if the user inputs a textual description (corresponding to the part of picture generated from text in FIG. 4) or input a picture with no style (corresponding to the part of picture generated from picture in FIG. 4) into the stylized picture generation model, the stylized picture generation model corresponding to the corresponding style (e.g., Style 1, Style 2, or Style 3) can generate corresponding stylized picture.

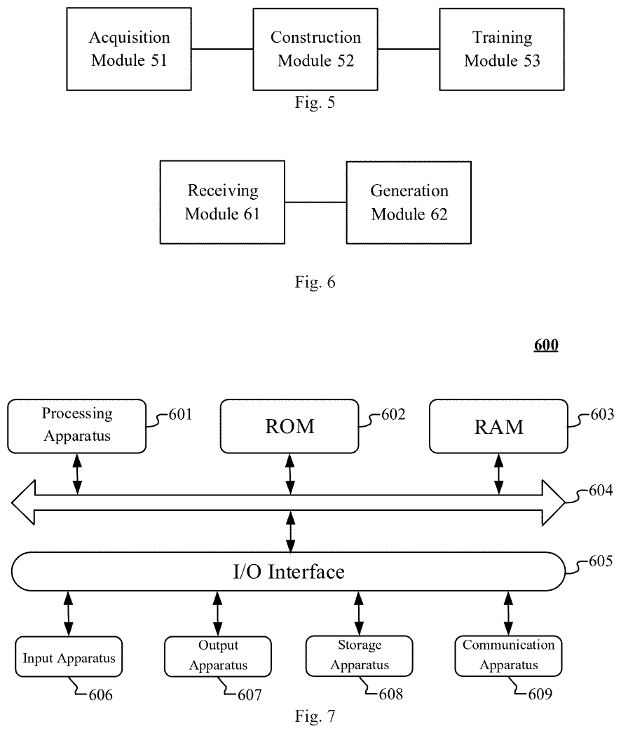

FIG. 5 is a schematic block diagram of an apparatus for training a stylized picture generation model according to an embodiment of the present disclosure. As shown in FIG. 5, the apparatus includes: an acquisition module 51 configured to acquire a stylized picture to be trained and a generic picture to be trained, where the generic picture to be trained is a picture which is similar in content to the stylized picture to be trained but does not possess style; a construction module 52 configured to construct training data based on the stylized picture to be trained and the generic picture to be trained, where the training data includes the stylized picture to be trained and a first text description paired with the stylized picture to be trained, and the generic picture to be trained and a second text description paired with the generic picture to be trained, where the first text description includes a style feature vector to be trained; and a training module 53 configured to train the stylized picture generation model based on the training data.

With the above-mentioned technical solution, the stylized picture to be trained and the generic picture to be trained possessing the similar content and their respective corresponding text descriptions are utilized to train the pictures of a certain style, and the text description of the stylized picture to be trained includes the style feature vector to be trained. That is, in the training process of the present disclosure, the stylized picture to be trained and the generic picture to be trained are combined for training, and the style feature vector to be trained is combined with the stylized picture generation model for training. Therefore, even though there are no sufficient stylized pictures of the same style, the stylized picture generation model can be trained with respect to the stylized pictures of the style type. Even though the style characteristics of the stylized pictures of a certain type cannot be described and tagged with explicit style words, the stylized picture generation model can be trained with respect to the stylized pictures of the style type. As a result, the method for training a stylized picture generation model according to the present disclosure can be enabled to train the stylized pictures of any style type defined by the user. Moreover, the method for training a stylized picture generation model according to the present disclosure further has the advantages of low training overhead, small training data requirement, low cost, simplicity and convenience, etc., and can achieve the training effect rapidly and facilitate personal training by the user.

Optionally, the construction module 52 is configured to construct the first text description by: generating a corresponding textual description for the stylized picture to be trained; and adding the style feature vector to be trained to the textual description to obtain the first text description.

Optionally, the construction module 52 is configured to construct the first text description by: receiving a textual description input by a user and corresponding to the stylized picture to be trained; and adding the style feature vector to be trained to the textual description to obtain the first text description.

Optionally, acquiring, by the acquisition module 51, the generic picture to be trained includes: generating a corresponding textual description for the stylized picture to be trained; and generating the generic picture to be trained based on the textual description.

Optionally, the acquisition module 51 is further configured to augment the generated generic picture to be trained at different scales after generating the generic picture to be trained based on the textual description.

Optionally, acquiring, by the acquisition module 51, the stylized picture to be trained includes: receiving a stylized picture input by a user; and augmenting the stylized picture input by the user at different scales to obtain the stylized picture to be trained.

Optionally, training, by the training module 53, the stylized picture generation model based on the training data includes: inputting the training data into the stylized picture generation model to obtain a stylized picture and a generic picture output by the stylized picture generation model; calculating a reconstruction loss between the stylized picture to be trained and the stylized picture output by the stylized picture generation model, and a reconstruction loss between the generic picture to be trained and the generic picture output by the stylized picture generation model; correcting the stylized picture generation model based on the reconstruction losses; and in response to the calculated reconstruction losses meeting a preset condition, obtaining a trained stylized picture generation model.

FIG. 6 is a schematic block diagram of an apparatus for generating a stylized picture according to an embodiment of the present disclosure. As shown in FIG. 6, the apparatus for generating a stylized picture includes: a receiving module 61 configured to receive a picture to be stylized input by a user; and a generation module 62 configured to process the picture to be stylized using a stylized picture generation model to generate the stylized picture, where the stylized picture generation model is a model trained based on the method for training a stylized picture generation model of the present disclosure.

With the above-mentioned technical solution, because the stylized picture generation model is the model trained based on the method for training a stylized picture generation model of the present disclosure, the stylized picture of the style desired by the user can be rapidly output for the user.

According to an embodiment of the present disclosure, a computer-readable medium is provided, which stores a computer program, and the computer program, when executed by a processing apparatus, implements the steps of the method of the present disclosure.

According to an embodiment of the present disclosure, an electronic device is provided, which includes: a storage apparatus storing a computer program; and a processing apparatus configured to execute the computer program in the storage apparatus to implement the steps of the method of the present disclosure.

Referring to FIG. 7, FIG. 7 illustrates a schematic structural diagram of an electronic device 600 suitable for implementing the embodiments of the present disclosure. The electronic device in the embodiments of the present disclosure may include but is not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and a fixed terminal such as a digital TV, a desktop computer, or the like. The electronic device illustrated in FIG. 7 is merely an example, and should not pose any limitation to the functions and the range of use of the embodiments of the present disclosure.

As illustrated in FIG. 7, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 608 into a random-access memory (RAM) 603. The RAM 603 further stores various programs and data required for operations of the electronic device 600. The processing apparatus 601, the ROM 602, and the RAM 603 are interconnected through a bus 604. An input/output (I/O) interface 605 is also connected to the bus 604.

Usually, the following apparatuses may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 7 illustrates the electronic device 600 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: acquire a stylized picture to be trained and a generic picture to be trained, where the generic picture to be trained is a picture which is similar in content to the stylized picture to be trained but does not possess style; construct training data based on the stylized picture to be trained and the generic picture to be trained, where the training data includes the stylized picture to be trained and a first text description paired with the stylized picture to be trained, and the generic picture to be trained and a second text description paired with the generic picture to be trained, where the first text description includes a style feature vector to be trained; and train the stylized picture generation model based on the training data.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the acquisition module can also be described as “a module for acquiring a stylized picture to be trained and a generic picture to be trained.”

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, example 1 provides a method for training a stylized picture generation model, including: acquiring a stylized picture to be trained and a generic picture to be trained, where the generic picture to be trained is a picture which is similar in content to the stylized picture to be trained but does not possess style; constructing training data based on the stylized picture to be trained and the generic picture to be trained, where the training data includes the stylized picture to be trained and a first text description paired with the stylized picture to be trained, and the generic picture to be trained and a second text description paired with the generic picture to be trained, and the first text description includes a style feature vector to be trained; and training the stylized picture generation model based on the training data.

According to one or more embodiments of the present disclosure, example 2 provides a method according to example 1, where the first text description is constructed by: generating a corresponding textual description for the stylized picture to be trained; and adding the style feature vector to be trained to the textual description to obtain the first text description.

According to one or more embodiments of the present disclosure, example 3 provides a method according to example 1, where the first text description is constructed by: receiving a textual description input by a user and corresponding to the stylized picture to be trained; and adding the style feature vector to be trained to the textual description to obtain the first text description.

According to one or more embodiments of the present disclosure, example 4 provides a method according to example 1, where acquiring the generic picture to be trained includes: generating a corresponding textual description for the stylized picture to be trained; and generating the generic picture to be trained based on the textual description.

According to one or more embodiments of the present disclosure, example 5 provides a method according to example 4, where after generating the generic picture to be trained based on the textual description, acquiring the generic picture to be trained further includes augmenting the generated generic picture to be trained at different scales.

According to one or more embodiments of the present disclosure, example 6 provides a method according to example 1, where acquiring the stylized picture to be trained includes: receiving a stylized picture input by a user; and augmenting the stylized picture input by the user at different scales to obtain the stylized picture to be trained.

According to one or more embodiments of the present disclosure, example 7 provides a method according to any one of example 1 to example 6, where training the stylized picture generation model based on the training data includes: inputting the training data into the stylized picture generation model to obtain a stylized picture and a generic picture output by the stylized picture generation model; calculating a reconstruction loss between the stylized picture to be trained and the stylized picture output by the stylized picture generation model, and a reconstruction loss between the generic picture to be trained and the generic picture output by the stylized picture generation model; correcting the stylized picture generation model based on the reconstruction losses; and in response to the calculated reconstruction losses meeting a preset condition, obtaining a trained stylized picture generation model.

According to one or more embodiments of the present disclosure, example 8 provides a method for generating a stylized picture, including: receiving a picture to be stylized input by a user; and processing the picture to be stylized using a stylized picture generation model to generate the stylized picture, where the stylized picture generation model is a model trained based on the method for training a stylized picture generation model according to any one of example 1 to example 7.

According to one or more embodiments of the present disclosure, example 9 provides an apparatus for training a stylized picture generation model, including: an acquisition module, configured to acquire a stylized picture to be trained and a generic picture to be trained, where the generic picture to be trained is a picture which is similar in content to the stylized picture to be trained but does not possess style; a construction module, configured to construct training data based on the stylized picture to be trained and the generic picture to be trained, where the training data includes the stylized picture to be trained and a first text description paired with the stylized picture to be trained, and the generic picture to be trained and a second text description paired with the generic picture to be trained, and the first text description includes a style feature vector to be trained; and a training module, configured to train the stylized picture generation model based on the training data.

According to one or more embodiments of the present disclosure, example 10 provides an apparatus for generating a stylized picture, including: a receiving module, configured to receive a picture to be stylized input by a user; and a generation module, configured to process the picture to be stylized using a stylized picture generation model to generate the stylized picture, where the stylized picture generation model is a model trained based on the method for training a stylized picture generation model according to any one of example 1 to example 7.

According to one or more embodiments of the present disclosure, example 11 provides a computer-readable medium, storing a computer program, where the computer program, when executed by a processing apparatus, implements steps of the method according to any one of example 1 to example 8.

According to one or more embodiments of the present disclosure, example 12 provides an electronic device, including: a storage apparatus storing a computer program; and a processing apparatus, configured to execute the computer program in the storage apparatus to implement steps of the method according to any one of example 1 to example 8.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims. Regarding the apparatuses in the above-mentioned embodiments, the specific manner in which each module performs operations has been described in detail in the embodiments related to the method, and will not be described in detail here.

1. A method for training a stylized picture generation model, comprising:
acquiring a stylized picture to be trained and a generic picture to be trained, wherein the generic picture to be trained is a picture which is similar in content to the stylized picture to be trained but does not possess style;
constructing training data based on the stylized picture to be trained and the generic picture to be trained, wherein the training data comprises the stylized picture to be trained and a first text description paired with the stylized picture to be trained, and the generic picture to be trained and a second text description paired with the generic picture to be trained, and the first text description comprises a style feature vector to be trained; and
training the stylized picture generation model based on the training data.

2. The method according to claim 1, wherein the first text description is constructed by:
generating a corresponding textual description for the stylized picture to be trained; and
adding the style feature vector to be trained to the textual description to obtain the first text description.

3. The method according to claim 1, wherein the first text description is constructed by:
receiving a textual description input by a user and corresponding to the stylized picture to be trained; and
adding the style feature vector to be trained to the textual description to obtain the first text description.

4. The method according to claim 1, wherein the acquiring the generic picture to be trained comprises:
generating a corresponding textual description for the stylized picture to be trained; and
generating the generic picture to be trained based on the textual description.

5. The method according to claim 4, wherein after the generating the generic picture to be trained based on the textual description, the acquiring the generic picture to be trained further comprises:
augmenting the generated generic picture to be trained at different scales.

6. The method according to claim 1, wherein the acquiring the stylized picture to be trained comprises:
receiving a stylized picture input by a user; and
augmenting the stylized picture input by the user at different scales to obtain the stylized picture to be trained.

7. The method according to claim 1, wherein the training the stylized picture generation model based on the training data comprises:
inputting the training data into the stylized picture generation model to obtain a stylized picture and a generic picture output by the stylized picture generation model;
calculating a reconstruction loss between the stylized picture to be trained and the stylized picture output by the stylized picture generation model, and a reconstruction loss between the generic picture to be trained and the generic picture output by the stylized picture generation model;
correcting the stylized picture generation model based on the reconstruction losses; and
in response to the calculated reconstruction losses meeting a preset condition, obtaining a trained stylized picture generation model.

8. A method for generating a stylized picture, comprising:
receiving a picture to be stylized input by a user; and
processing the picture to be stylized using a stylized picture generation model to generate the stylized picture, wherein the stylized picture generation model is a model trained based on a method for training a stylized picture generation model, and the method for training a stylized picture generation model comprises:
acquiring a stylized picture to be trained and a generic picture to be trained, wherein the generic picture to be trained is a picture which is similar in content to the stylized picture to be trained but does not possess style;
constructing training data based on the stylized picture to be trained and the generic picture to be trained, wherein the training data comprises the stylized picture to be trained and a first text description paired with the stylized picture to be trained, and the generic picture to be trained and a second text description paired with the generic picture to be trained, and the first text description comprises a style feature vector to be trained; and
training the stylized picture generation model based on the training data.

9-10. (canceled)

11. A non-transitory computer-readable medium, storing a computer program, wherein the computer program, when executed by a processing apparatus, implements the method according to claim 1.

12. An electronic device, comprising:
a storage apparatus storing a computer program; and
a processing apparatus, configured to execute the computer program in the storage apparatus to implement a method for training a stylized picture generation model, and the method for training a stylized picture generation model comprises:
acquiring a stylized picture to be trained and a generic picture to be trained, wherein the generic picture to be trained is a picture which is similar in content to the stylized picture to be trained but does not possess style;
constructing training data based on the stylized picture to be trained and the generic picture to be trained, wherein the training data comprises the stylized picture to be trained and a first text description paired with the stylized picture to be trained, and the generic picture to be trained and a second text description paired with the generic picture to be trained, and the first text description comprises a style feature vector to be trained; and
training the stylized picture generation model based on the training data.

13. (canceled)

14. The method according to claim 2, wherein the acquiring the generic picture to be trained comprises:
generating a corresponding textual description for the stylized picture to be trained; and
generating the generic picture to be trained based on the textual description.

15. The method according to claim 3, wherein the acquiring the generic picture to be trained comprises:
generating a corresponding textual description for the stylized picture to be trained; and
generating the generic picture to be trained based on the textual description.

16. The method according to claim 2, wherein the acquiring the stylized picture to be trained comprises:
receiving a stylized picture input by a user; and
augmenting the stylized picture input by the user at different scales to obtain the stylized picture to be trained.

17. The method according to claim 3, wherein the acquiring the stylized picture to be trained comprises:
receiving a stylized picture input by a user; and
augmenting the stylized picture input by the user at different scales to obtain the stylized picture to be trained.

18. The method according to claim 4, wherein the acquiring the stylized picture to be trained comprises:
receiving a stylized picture input by a user; and
augmenting the stylized picture input by the user at different scales to obtain the stylized picture to be trained.

19. The method according to claim 5, wherein the acquiring the stylized picture to be trained comprises:
receiving a stylized picture input by a user; and
augmenting the stylized picture input by the user at different scales to obtain the stylized picture to be trained.

20. The method according to claim 2, wherein the training the stylized picture generation model based on the training data comprises:
inputting the training data into the stylized picture generation model to obtain a stylized picture and a generic picture output by the stylized picture generation model;
calculating a reconstruction loss between the stylized picture to be trained and the stylized picture output by the stylized picture generation model, and a reconstruction loss between the generic picture to be trained and the generic picture output by the stylized picture generation model;
correcting the stylized picture generation model based on the reconstruction losses; and
in response to the calculated reconstruction losses meeting a preset condition, obtaining a trained stylized picture generation model.

21. The method according to claim 3, wherein the training the stylized picture generation model based on the training data comprises:
inputting the training data into the stylized picture generation model to obtain a stylized picture and a generic picture output by the stylized picture generation model;
calculating a reconstruction loss between the stylized picture to be trained and the stylized picture output by the stylized picture generation model, and a reconstruction loss between the generic picture to be trained and the generic picture output by the stylized picture generation model;
correcting the stylized picture generation model based on the reconstruction losses; and
in response to the calculated reconstruction losses meeting a preset condition, obtaining a trained stylized picture generation model.

22. A non-transitory computer-readable medium, storing a computer program, wherein the computer program, when executed by a processing apparatus, implements the method according to claim 8.

23. An electronic device, comprising:
a storage apparatus storing a computer program; and
a processing apparatus, configured to execute the computer program in the storage apparatus to implement the method according to claim 8.
